(19) United States
(12) Patent Application Publication
(10) Pub. No.: US 2023/0106779 A1
(43) Pub. Date: Apr. 6, 2023

(54) ELECTRODE FOR LITHIUM-ION SECONDARY BATTERY, AND LITHIUM-ION SECONDARY BATTERY

(71) Applicant: HONDA MOTOR CO., LTD., Tokyo (JP)

(72) Inventors: Ken BABA, Saitama (JP); Kazuaki MATSUMOTO, Saitama (JP)

(21) Appl. No.: 17/802,973

(22) PCT Filed: Mar. 10, 2020
(86) PCT No.: PCT/JP2020/010340

§ 371 Date: Dec. 14, 2022

(51) Int. Cl. H01M 10/0562; H01M 10/0525

(52) U.S. Cl. CPC H01M 10/0562; H01M 10/0525; H01M 2004/021

(57) ABSTRACT

Provided are: an electrode for a lithium-ion secondary battery, said electrode enabling a battery having a high volumetric energy density to be attained, without reducing heat stability, even if a positive electrode active material that contains a high percentage of Ni is used; and a lithium-ion secondary battery that uses the positive electrode. An electrolyte and highly-dielectric solid particles are present in an electrode mixture layer at a specific volume ratio. Specifically, the electrode for a lithium-ion battery is configured such that the electrode mixture layer includes an electrode active material, a highly-dielectric solid oxide, and an electrolyte, wherein the volume ratio of the electrolyte and the highly-dielectric solid oxide in the electrode mixture layer is set in the range of 99:1 to 76:24.

### TECHNICAL FIELD

The present invention relates to a lithium-ion secondary battery electrode and to a lithium-ion secondary battery including the electrode according to the present invention.

### BACKGROUND ART

In the conventional art, lithium-ion secondary batteries are in widespread use for their high energy density. A liquid electrolyte is used for lithium-ion secondary batteries. Such lithium-ion secondary batteries have a structure including: positive and negative electrodes; and a separator provided between the positive and negative electrodes and filled with the liquid electrolyte (electrolytic solution).

Such lithium-ion secondary batteries are faced with different needs depending on their use, such as a need for a further increase in volumetric energy density for automobile applications. To address such a need, a method is proposed using a Ni-based positive electrode active material (see Patent Document 1).

Unfortunately, the use of such a positive electrode active material with a high Ni content, such as LiNi_{0.8}Co_{0.15}Al_{0.05}O₂ (NCA), causes the problem of a reduction in thermal stability.
Patent Document 1: Japanese Unexamined Patent Application, Publication No. 2000-200624

### DISCLOSURE OF THE INVENTION

### Problems to be Solved by the Invention

The present invention has been made in light of the background art described above. It is an object of the present invention to provide a lithium-ion secondary battery electrode that can be used to form a high volumetric energy density battery with no reduction in thermal stability even when including a positive electrode active material with a high Ni content and to provide a lithium-ion secondary battery including such a positive electrode.

### Means for Solving the Problems

As a result of intensive studies, the inventors have completed the present invention based on findings that an electrode material mixture layer containing an electrolytic solution and high-dielectric solid particles in a specific volume ratio provides a solution to the problem stated above.

Specifically, an aspect of the present invention is directed to a lithium-ion secondary battery electrode having an electrode material mixture layer including an electrode active material, a high-dielectric oxide solid, and an electrolytic solution, in which the electrolytic solution and the high-dielectric oxide solid are in a volume ratio of 99:1 to 76:24 in the electrode material mixture layer.

The high-dielectric oxide solid and the electrolytic solution may be disposed in spaces between particles of the electrode active material.

The electrolytic solution may contain an aprotic polar solvent with a boiling point of 150° C. or more, and the electrode material mixture layer may have a ratio (A/B) of the mole fraction (A) of the aprotic polar solvent to the total specific surface area (B) (m²) of the high-dielectric oxide solid of 0.5 or more.

The electrode material mixture layer may have a differential scanning calorimetry (DSC) curve with a reduction in exothermic peak at 270° C.

The high-dielectric oxide solid may be a solid oxide electrolyte.

The solid oxide electrolyte may be at least one selected from the group consisting of Li₇La₃Zr₂O₁₂ (LLZO), Li_{0.75}La₃Zr_{1.75}Ta_{0.25}O₁₂ (LLZTO), Li_{0.33}La_{0.54}TiO₃ (LLTO), Li_{1.3}Al_{0.3}Ti_{1.7}(PO₄)₃ (LATP), and Li_{1.6}Al_{0.6}Ge_{1.4}(PO₄)₃ (LAGP).

The electrode active material may have a volume filling factor of 60% or more based on the total volume of the electrode material mixture in the electrode.

The electrode material mixture layer may have a thickness of 40 μm or more.

The lithium-ion secondary battery electrode may be a positive electrode.

The lithium-ion secondary battery electrode may be a negative electrode.

Another aspect of the present invention is directed to a lithium-ion secondary battery, including the lithium-ion secondary battery electrode defined above and an electrolytic solution.

### Effects of the Invention

Even when including a positive electrode active material with a high Ni content, the lithium-ion secondary battery electrode according to the present invention can be used to form a high volumetric energy density battery with no reduction in thermal stability.

### BRIEF DESCRIPTION OF THE DRAWINGS

FIG. 1 is a view of a lithium-ion secondary battery according to an embodiment of the present invention;

FIG. 2 is a graph showing DSC curves in examples and a comparative example; and

FIG. 3 is a graph showing DSC curves in examples and a comparative example.

### PREFERRED MODE FOR CARRYING OUT THE INVENTION

Hereinafter, embodiments of the present invention will be described. It should be noted that the embodiments below are not intended to limit the present invention.

Lithium-Ion Secondary Battery Electrode

The lithium-ion secondary battery electrode according to the present invention has an electrode material mixture layer including an electrode active material, a high-dielectric oxide solid, and an electrolytic solution, in which the volume ratio of the electrolytic solution to the high-dielectric oxide solid in the electrode material mixture layer is 99:1 to 76:24.

The lithium-ion secondary battery electrode according to the present invention may be a positive or negative electrode for use in lithium-ion secondary batteries. Preferably, the lithium-ion secondary battery electrode according to the present invention is a positive electrode, so that it will be more advantageous when including a positive electrode active material with a high Ni content.

The lithium-ion secondary battery electrode according to the present invention may have any appropriate construction. For example, the lithium-ion secondary battery electrode according to the present invention may include an electrode current collector; and an electrode material mixture layer that is disposed on the current collector, includes an electrode active material and a high-dielectric oxide solid, and is impregnated with an electrolytic solution.

(Current Collector)

In the lithium-ion secondary battery electrode according to the present invention, the current collector may be any type, such as a known current collector suitable for use in lithium-ion secondary batteries.

The positive electrode current collector may be made of, for example, a metallic material, such as SUS, Ni, Cr, Au, Pt, Al, Fe, Ti, Zn, or Cu. The negative electrode current collector may be made of, for example, SUS, Ni, Cu, Ti, Al, baked carbon, electrically conductive polymer, electrically conductive glass, or Al—Cd alloy.

The electrode current collector may be in the form of, for example, a foil, a plate or sheet, or a mesh. The electrode current collector may have any appropriate thickness selected depending on need, which is, for example, 1 to 20 μm.

(Electrode Material Mixture Layer)

In the lithium-ion secondary battery electrode according to the present invention, the electrode material mixture layer includes, as essential components, an electrode active material and a high-dielectric oxide solid. The electrode material mixture layer should be provided on at least one side of the current collector. The electrode material mixture layer may be provided on each of the two sides of the current collector. Where to dispose the electrode material mixture layer may be selected as appropriate depending on the type or structure of the desired lithium-ion secondary battery.

The electrode material mixture layer may further include any optional component, in addition to the essential components according to the present invention: the electrode active material and the high-dielectric oxide solid. Examples of the optional component include a conductive aid, a binder, and any other known component.

(Volume Ratio of Electrolytic Solution to High-Dielectric Oxide Solid in Electrode Material Mixture Layer)

In the lithium-ion secondary battery electrode according to the present invention, the electrode material mixture layer has a volume ratio of the electrolytic solution to the high-dielectric oxide solid in the range of 99:1 to 76:23. The volume ratio is preferably in the range of 98:2 to 81:19, more preferably in the range of 97:3 to 85:15.

The addition of the dielectric particles, which have high thermal stability, to the positive electrode prevents crystal structure distortion, reduces variations in the valence of transition metals, such as Ni and Co, and stabilizes the crystal structure of the active material. This is considered to result in prevention of dissolution of transition metals from the positive electrode active material, prevention of elimination of oxygen from the positive electrode active material, and prevention of a reaction of the positive electrode active material with the electrolytic solution. This is also considered effective in trapping hydrogen fluoride, which forms when an electrolyte LiPF₆ undergoes a decomposition reaction, so that the reaction will be prevented from further proceeding.

(Thickness of the Electrode Material Mixture Layer)

In the lithium-ion secondary battery electrode according to the present invention, the thickness of the electrode material mixture layer is preferably, but not limited to, 40 μm or more. The electrode material mixture layer with a thickness of 40 μm or more and a volume filling factor of the electrode active material of 60% or more will form a high-density electrode suitable for use in lithium-ion secondary batteries. It can also form a battery cell with a volumetric energy density as high as 500 Wh/L or more.

(Electrode Active Material)

In the lithium-ion secondary battery electrode according to the present invention, the electrode active material may be any type capable of storing and releasing lithium ions. The electrode active material may be any known active material suitable for use in lithium-ion secondary batteries.

(Positive Electrode Active Material)

In a case where the lithium-ion secondary battery electrode according to the present invention is a positive electrode, the positive electrode active material is typically, but not limited to, LiCoO₂, LiCoO₄, LiMn₂O₄, LiNiO₂, LiFePO₄, lithium sulfide, or sulfur. The positive electrode active material may be selected from materials that are suitable for forming the electrode and have a more noble potential than that of the negative electrode.

The lithium-ion secondary battery electrode according to the present invention may include a positive electrode active material with a high Ni content. Even in such a case, the lithium-ion secondary battery electrode according to the present invention can be used to form a high volumetric energy density battery with no reduction in thermal stability. Thus, the present invention is highly advantageous in a case where the electrode according to the present invention includes a positive electrode active material with a high Ni content, such as LiNi_{0.8}Co_{0.15}Al_{0.05}O₂ (NCA).

(Negative Electrode Active Material)

The lithium-ion secondary battery electrode according to the present invention may be a negative electrode. In this case, examples of the negative electrode active material include metallic lithium, lithium alloy, metal oxide, metal sulfide, metal nitride, silicon oxide, silicon, and carbon materials, such as graphite. The negative electrode active material may be selected from materials that are suitable for forming the electrode and have a more base potential than that of the positive electrode.

(Volume Filling Factor of Electrode Active Material)

In the lithium-ion secondary battery electrode according to the present invention, the electrode active material preferably has a volume filling factor of 60% or more based on the total volume of the electrode material mixture layer. When the electrode active material has a volume filling factor of 60% or more, the spaces between the particles of the electrode active material will make up less than 401 of the total volume of the electrode material mixture layer. This means that the lithium-ion secondary battery electrode has a low porosity and thus has a high volumetric energy density. With a volume filling factor of 60% or more, the electrode active material can form a cell having a volumetric energy density, for example, as high as 500 Wh/L or more.

In the present invention, the volume filling factor of the electrode active material is more preferably 65% or more, most preferably 70% or more, based on the total volume of the electrode material mixture in the electrode.

(High-Dielectric Oxide Solid)

In the lithium-ion secondary battery electrode according to the present invention, the high-dielectric oxide solid may be any oxide with high dielectric properties. In general, the permittivity of particles obtained by pulverization of a crystalline solid is lower than that of the original crystalline solid. In the present invention, therefore, the high-dielectric oxide solid is preferably in the form of a powder obtained by such a pulverization process that the dielectric properties are kept as high as possible.

(Relative Permittivity of Powder)

In the present invention, the high-dielectric oxide solid is preferably in the form of a powder with a relative permittivity of 10 or more, more preferably in the form of a powder with a relative permittivity of 20 or more. The powder with a relative permittivity of 10 or more is sufficiently effective in achieving a lithium-ion secondary battery that has high resistance to charge-discharge cycles and of which the internal resistance does not increase so much even during repeated charge-discharge cycles.

As used herein, the term “the relative permittivity of a powder” refers to the value determined as described below.

(Method of Measuring the Relative Permittivity of Powder)

The powder is introduced into a tablet molding machine with a diameter (R) of 38 mm for analysis and compressed into a compact with a thickness (d) of 1 to 2 mm using a hydraulic press machine. The compact is formed under conditions that allow the relative density of the powder (D_{powder}=(compact weight density/dielectric true specific gravity)×100) to reach 40% or more. The capacitance (Cₜₒₜₐₗ) of the compact is measured with an LCR meter at 25° C. and 1 kHz according to automatically balanced bridge method and then used to calculate the relative permittivity (εₜₒₜₐₗ) of the compact. The relative permittivity (ε_{powder}) of the powder was calculated by calculating the permittivity (ε_{powder}) of the solid volume fraction from the relative permittivity of the compact using Formulae (1), (2), and (3) below in which ca is the vacuum permittivity (=3.854×10⁻¹²) and εₐᵢᵣ is the relative permittivity of air (=1).

Contact area A between the compact and the electrode=(R/2)²·π (1)

Cₜₒₜₐₗ=εₜₒₜₐₗ×ε₀×(A/d) (2)

εₜₒₜₐₗ=ε_{powder}×D_{powder}+εₐᵢᵣ×(1−D_{powder}) (3)

(Particle Size)

The particles of the high-dielectric oxide solid may have any appropriate size. Preferably, the particles of the high-dielectric oxide solid have a size of 0.01 μm or more and about 10 μm or less, which is smaller than or equal to the size of the particles of the active material. High-dielectric oxide solid particles of too large a size may interfere with the improvement of the filling factor of the active material in the electrode.

(Arrangement of High-Dielectric Oxide Solid)

In the lithium-ion secondary battery electrode according to the present invention, the high-dielectric oxide solid is preferably disposed in spaces between particles of the electrode active material in the electrode material mixture layer. The spaces between particles of the electrode active material can be controlled by controlling the filling factor of the electrode active material, which correlates with the density of the electrode material mixture layer. The spaces between particles of the electrode active material may also contain a binder, such as a resin binder, a conductive aid for imparting electron conductivity, such as a carbon material, or other materials.

The high-dielectric oxide solid disposed in spaces between particles of the electrode active material will provide a high filling density of the electrode active material for the lithium-ion secondary battery electrode according to the present invention, will prevent a reduction in the diffusion of lithium ions in the electrode, and thus will prevent a corresponding increase in resistance. This makes it possible to provide a lithium-ion secondary battery that has a high volumetric energy density and is less vulnerable to a repeated charge and discharge-induced reduction in power even when the electrode holds a relatively small amount of the electrolytic solution.

The high-dielectric oxide solid disposed in spaces between particles of the electrode active material also improves the ability of the electrolytic solution to penetrate the lithium-ion secondary battery electrode according to the present invention. This leads the electrode to hold the electrolytic solution more uniformly. This also reduces the time required for the electrode to be impregnated with the electrolytic solution and thus improves productivity.

The high-dielectric oxide solid disposed in spaces between particles of the electrode active material further prevents dielectric effect-induced association between lithium ions and anions in the lithium-ion secondary battery electrode according to the present invention. This is effective in reducing the resistance, for example, even in a case where the electrode includes an electrolytic solution containing a lithium salt at a high concentration.

An electrode material mixture paste containing the high-dielectric oxide solid may be prepared for forming the electrode material mixture layer. In this case, it is easy to form an electrode material mixture layer having the high-dielectric oxide solid disposed in spaces between particles of the electrode active material, and it is also easy to achieve substantially uniform distribution of the high-dielectric oxide solid over the electrode material mixture layer. The electrode material mixture paste may also be prepared by allowing the high-dielectric oxide solid to adhere to a conductive aid or a binder and then mixing them with the electrode active material. In this case, the dielectric solid particles can be more uniformly disposed in spaces between particles of the electrode active material.

(Type of High-Dielectric Oxide Solid)

The high-dielectric oxide solid may be any oxide with high dielectric properties. Preferably, the high-dielectric oxide solid is a solid oxide electrolyte. The solid oxide electrolyte is inexpensively available in the form of crystals and has high resistance to electrochemical oxidation and reduction. The solid oxide electrolyte has a relatively low true specific gravity and thus helps to prevent an increase in electrode weight.

The high-dielectric oxide solid is more preferably a solid oxide electrolyte having lithium-ion conductivity. The lithium-ion-conductive, high-dielectric, solid oxide electrolyte can form a lithium-ion secondary battery having higher power at low temperature. The lithium-ion-conductive, high-dielectric, solid oxide electrolyte also helps to form, at relatively low cost, a lithium-ion secondary battery electrode having high resistance to electrochemical oxidation and reduction.

Examples of the high-dielectric oxide solid include complex metal oxides having a perovskite crystal structure, such as BaTiO₃, BaₓSr₁₋ₓTiO₃, wherein x is 0.4 to 0.8, BaZrₓT₁₋ₓO₃, wherein X is 0.2 to 0.5, and KNbO₃; and bismuth-containing complex metal oxides having a layered perovskite crystal structure, such as SrBi₂Ta₂O₉ and SrBi₂Nb₂O₉.

The high-dielectric oxide solid is preferably lithium-ion conductive and more preferably at least one selected from the group consisting of Li₇La₃Zr₂O₁₂ (LLZO), Li_{0.75}La₃Zr_{1.75}Ta_{0.25}O₁₂ (LLZTO), Li_{0.33}La_{0.54}TiO₃ (LLTO), Li_{1.3}Al_{0.3}Ti_{1.7}(PO₄)₃ (LATP), and Li_{1.6}Al_{0.6}Ge_{1.4}(PO₄)₃ (LAGP).

The content of the high-dielectric oxide solid in the electrode material mixture layer is preferably in the range of 0.05 to 10% by mass, more preferably in the range of 0.1 to 8% by mass, even more preferably in the range of 0.2 to 5% by mass, based on the total mass of the electrode material mixture layer. The high-dielectric oxide solid content in the range of 0.1 to 6% by mass is effective in reducing resistance and increasing durability.

(Electrolytic Solution)

In the lithium-ion secondary battery electrode according to the invention, the electrolytic solution, which is disposed in spaces between particles of the electrode active material, may be any suitable electrolytic solution known for use in lithium-ion secondary batteries. The electrolytic solution used to form a secondary battery having a lithium-ion secondary battery electrode according to the present invention may be the same as or different from the electrolytic solution disposed in the lithium-ion secondary battery electrode according to the present invention.

(Solvent)

The solvent for the electrolytic solution may be a common solvent used to form a non-aqueous electrolytic solution. Examples of such a solvent include cyclic structure-containing solvents, such as ethylene carbonate (EC) and propylene carbonate (PC); and chain structure-containing solvents, such as dimethyl carbonate (DMC), ethyl methyl carbonate (EMC), and diethyl carbonate (DEC). The solvent may also be a partially fluorinated compound, such as fluoroethylene carbonate (FEC) or difluoroethylene carbonate (DFEC).

The electrolytic solution may also contain a known additive, examples of which include vinylene carbonate (VC), vinylethylene carbonate (VEC), propanesultone (PS), and fluoroethylene carbonate (FEC).

The electrolytic solution may also contain an ionic liquid. The ionic liquid may include a quaternary ammonium cation, such as pyrrolidinium, piperidinium, or imidazolium.

In the lithium-ion secondary battery electrode according to the present invention, the electrolytic solution preferably contains a mixture of a solvent with high relative permittivity, such as EC or PC, and a solvent with low viscosity, such as DMC or EMC. In a case where a solvent with high relative permittivity is used, a lithium salt can be used at a high concentration and can exhibit a high degree of dissociation. Only a solvent with high relative permittivity will provide a high viscosity and thus provide a reduced ionic conductivity. To adjust the viscosity, therefore, a suitable amount of a low viscosity solvent should be mixed with the solvent with high relative permittivity. The content of the solvent with high relative permittivity, such as EC or PC, in the electrolytic solution is preferably 20% by volume or more and 40% by volume or less. More preferably, it is 25% by volume or more and 35% by volume or less.

In the lithium-ion secondary battery electrode according to the present invention, the electrolytic solution, which is disposed in spaces between particles of the electrode active material in the electrode material mixture layer, preferably contains an aprotic polar solvent with a boiling point of 150° C. or more, and the ratio (A/B) of the mole fraction (A) of the aprotic polar solvent to the total specific surface area (B) (m²) of the high-dielectric oxide solid is preferably 0.5 or more. The ratio (A/B) of the mole fraction (A) of the aprotic polar solvent to the total specific surface area (B) (m²) of the high-dielectric oxide solid is more preferably 0.7 or more, even more preferably 1.0 or more. In a case where the ratio (A/B) is 0.5 or more, improved thermal stability will be provided with no reduction in ionic conductivity.

The aprotic polar solvent with a boiling point of 150° C. or more may be, for example, ethylene carbonate, propylene carbonate, or fluoroethylene carbonate.

As used herein, the term “the total specific surface area (B) (m²) of the high-dielectric oxide solid” refers to the value calculated by the formula: the total specific surface area (B) (m²) of the high-dielectric oxide solid=BET specific surface area (m²/g) x the weight of the high-dielectric oxide solid. The BET specific surface area is the value measured by a process that includes drying the high-dielectric oxide solid powder under reduced pressure at 100° C. for 12 hours and then analyzing the dried powder with Macsorb available from Mountech Co., Ltd.

(Lithium Salt)

In the lithium-ion secondary battery electrode according to the present invention, the electrolytic solution, which is disposed in spaces between particles of the electrode active material, contains a lithium salt, which is typically, but not limited to, LiPF₆, LiBF₄, LiClO₄, LiN(SO₂CF₃), LiN(SO₂C₂F₅)₂, or LiCF₃SO₃. In particular, LiPF₆, LiBF₄, or a mixture of LiPF₆ and LiBF₄ is preferred since they have high ionic conductivity and high degree of dissociation.

The electrolytic solution disposed in spaces between particles of the electrode active material should have a lithium salt concentration in the range of 0.5 to 3.0 mol/L. The lithium salt at a concentration of less than 0.5 mol/L may provide low ionic conductivity, while the lithium salt at a concentration of more than 3.0 mol/L may provide high viscosity and thus low ionic conductivity, which may make it difficult for the solid oxide to be sufficiently effective.

In the present invention, the lithium salt concentration of the electrolytic solution disposed in spaces between particles of the electrode active material is preferably in the range of 1.0 to 3.0 mol/L, most preferably in the range of 1.2 to 2.2 mol/L for high output performance after durability testing.

In general, an electrolytic solution with a high concentration of a lithium salt will have high viscosity and thus have a low ability to permeate electrodes. In the lithium-ion secondary battery electrode according to the present invention, however, the electrolytic solution has a high ability to permeate the electrode since the high-dielectric oxide solid exists in spaces between particles of the electrode active material.

In general, an electrolytic solution with a high lithium concentration tends to have low ionic conductivity due to the dissociation between lithium ions and anions. In the lithium-ion secondary battery electrode according to the present invention, however, the electrolytic solution will have improved ionic conductivity due to the high-dielectric oxide solid existing in spaces between particles of the electrode active material.

In the lithium-ion secondary battery electrode according to the present invention, therefore, the electrolytic solution disposed in spaces between particles of the electrode active material can have a higher lithium salt concentration than conventional electrolytic solutions for lithium-ion secondary batteries. Even in a case where the electrolytic solution with such a high concentration is used, it will take only a short time for the electrode to be impregnated with the electrolytic solution, which will improve productivity, and thus a battery with a high initial capacity will be provided.

(DSC Curve of the Electrode Material Mixture Layer)

In the lithium-ion secondary battery electrode according to the present invention, the electrode material mixture layer may have a DSC curve with a reduction in exothermic peak at 270° C. The term “reduction in exothermic peak” is intended to include not only substantial disappearance of the peak but also an intensity reduction caused by peak shift. This feature leads to a reduction in the heat generated by the decomposition reaction of an electrolyte LiPF₆ and to a reduction in the heat generated by the oxidation of an organic solvent through deoxidization and thus helps to improve thermal stability.

(Method for Manufacturing Lithium-Ion Secondary Battery Electrode)

The lithium-ion secondary battery electrode according to the present invention may be manufactured using any suitable methods commonly used in the art. For example, the lithium-ion secondary battery electrode according to the present invention may be manufactured by a method including: applying, onto an electrode current collector, an electrode material mixture paste including an electrode active material and a high-dielectric oxide solid as essential components; then drying the paste; then subjecting the product to rolling; and then impregnating the rolled product with an electrolytic solution. In this process, the volume filling factor of the electrode active material (namely, the proportion of spaces formed between particles of the electrode active material) can be controlled by changing the pressing pressure for the rolling.

A known method may be used to apply the electrode material paste to the electrode current collector. Examples include roller coating with an applicator roll, screen coating, blade coating, spin coating, bar coating, and other coating methods.

(Lithium-Ion Secondary Battery)

The present invention is also directed to a lithium-ion secondary battery including: the lithium-ion secondary battery electrode according to the present invention; and an electrolytic solution. In the lithium-ion secondary battery according to the present invention, one or each of the positive and negative electrodes may be the lithium-ion secondary battery electrode according to the present invention.

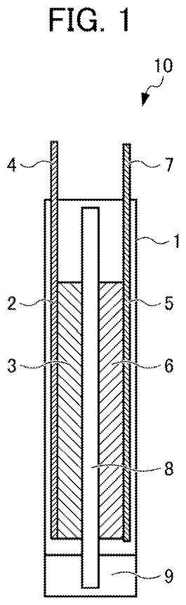

FIG. 1 is a view of a lithium-ion secondary battery according to an embodiment of the present invention. Referring to FIG. 1, the lithium-ion secondary battery 10 includes a positive electrode 4 including a positive electrode current collector 2 and a positive electrode material mixture layer 3 provided on the current collector 2; a negative electrode 7 including a negative electrode current collector 5 and a negative electrode material mixture layer 6 provided on the current collector 5; a separator 6 that electrically insulates the positive and negative electrodes 4 and 7 from each other; an electrolytic solution 9; and a container 1 that accommodates the positive and negative electrodes 4 and 7, the separator 8, and the electrolytic solution 9.

In the container 1, the positive and negative material mixture layers 3 and 6 are arranged opposite to each other with the separator 8 in between them, and the electrolytic solution 9 is stored below the positive and negative material mixture layers 3 and 6. The separator 8 has an end portion immersed in the electrolytic solution 9. One or each of the positive and negative electrodes 4 and 7 is the lithium-ion secondary battery electrode according to the present invention including an electrode active material, a high-dielectric oxide solid, and an electrolytic solution, in which the high-dielectric oxide solid and the electrolytic solution are disposed in spaces between particles of the electrode active material.

(Positive and Negative Electrodes)

In the lithium-ion secondary battery according to the present invention, one or each of the positive and negative electrodes is the lithium-ion secondary battery electrode according to the present invention. In a case where only the positive electrode is the lithium-ion secondary battery electrode according to the present invention, the negative electrode may be a sheet of a metal, a carbon material, or any other negative electrode active material.

(Electrolytic Solution)

The lithium-ion secondary battery according to the present invention may include any known suitable electrolytic solution. The electrolytic solution used to form the lithium-ion secondary battery may be the same as or different from the electrolytic solution disposed in the lithium-ion secondary battery electrode according to the present invention.

Method for Manufacturing Lithium-Ion Secondary Battery

The lithium-ion secondary battery according to the present invention may be manufactured using any methods commonly used in the art.

### EXAMPLES

Next, the present invention will be described in more detail with reference to examples and so on, which are not intended to limit the present invention.

### Example 1

(Preparation of Positive Electrode)

Acetylene black (a conductive aid) and Li_{1.3}Al_{0.3}Ti_{1.7} (PO₄)₃ (LATP) (a solid oxide electrolyte) were mixed and dispersed using a planetary centrifugal mixer to form a mixture. Subsequently, polyvinylidene fluoride (PVDF) (a binder) and LiNi_{0.8}Co_{0.15}Al_{0.05}O₂ (NCA) (a positive electrode active material) were added to the mixture. The resulting mixture was subjected to dispersion treatment using a planetary mixer to give a positive electrode material mixture. The mass proportions of the components in the positive electrode material mixture were positive electrode active material:LATP:conductive aid:resin binder (PVDF)=93.6:0.5:4.1:1.8. This means that the materials were mixed so that the positive electrode material mixture contained 0.5% by mass of LATP. Subsequently, the positive electrode material mixture was dispersed in N-methyl-2-pyrrolidone (NMP) to form a positive electrode material mixture paste.

A 12 μm-thick aluminum foil was prepared as a current collector. The positive electrode material mixture paste was applied to one side of the current collector and then dried at 120° C. for 10 minutes. The resulting product was roll-pressed at a linear pressure of 1 t/cm and then dried in vacuo at 120° C. to give a lithium-ion secondary battery positive electrode. The resulting positive electrode was subjected to punching so that a positive electrode piece of 30 mm×40 mm was obtained before use.

In the resulting lithium-ion secondary battery positive electrode, the electrode material mixture layer was 65 yin in thickness. The volume filling factor of the electrode active material was 67.4% based on the total volume of the electrode material mixture. The measurement methods are shown below.

(Method for Determining the Thickness of the Electrode Material Mixture Layer)

The resulting lithium-ion secondary battery positive electrode had the current collector foil and the electrode material mixture layer integrated with each other. The thickness of the electrode material mixture layer was determined by measuring the total thickness of them with a thickness gauge and subtracting the thickness of the current collector foil from the total thickness.

(How to Determine the Volume Ratio between the Electrolytic Solution and the High-Dielectric Oxide Solid in the Electrode Material Mixture Layer and to Determine the Volume Filling Factor of the Electrode Active Material Based on the Total Volume of the Electrode Material Mixture Layer)

After the preparation of the lithium-ion secondary battery positive electrode, the density of the electrode material mixture was determined from the dry weight (weight per unit area) of the electrode material mixture layer, which was measured in advance, and the thickness of the electrode obtained after the pressing. The volume occupied by each component of the electrode material mixture was calculated from the weight proportion and true specific gravity (g/cm³) of each component in the electrode. The calculated volumes were used to calculate the volume ratio between the electrolytic solution and the high-dielectric oxide solid and to calculate the volume filling factor of the electrode active material based on the total volume of the electrode material mixture layer. The true specific gravity of the positive electrode active material used in this example was 4.7 g/cm³.

(Preparation of Negative Electrode)

Sodium carboxymethylcellulose (CMC) (a binder) and acetylene black (a conductive aid) were mixed and dispersed using a planetary mixer to form a mixture. Artificial graphite (AG) (D50: 12 μm) (a negative electrode active material) was added to the mixture. The resulting mixture was subjected to dispersion treatment using a planetary mixer again to give a negative electrode material mixture. Subsequently, the negative electrode material mixture was dispersed in N-methyl-2-pyrrolidone (MP), and styrene-butadiene rubber (SBR) (a binder) was added to the resulting dispersion to form a negative electrode material mixture paste in which the mass proportions of the components were negative electrode active material:conductive aid:styrene-butadiene rubber (SBR):binder (CMC)=96.5:1:1.5:1.

A 12 μm-thick copper foil was prepared as a current collector. The negative electrode material mixture paste was applied to one side of the current collector and then dried at 100° C. for 10 minutes. The resulting product was roll-pressed at a linear pressure of 1 t/cm and then dried in vacuo at 100° C. to give a lithium-ion secondary battery negative electrode. The resulting negative electrode was subjected to punching so that a negative electrode piece of 34 mm×44 mm was obtained before use.

The thickness of the electrode material mixture layer in the resulting lithium-ion secondary battery negative electrode was determined by the same method as for the positive electrode described above. The determined thickness was 77 μm.

(Preparation of Lithium-Ion Secondary Battery)

The separator prepared was a nonwoven fabric laminate (20 μm thick) of three layers: polypropylene/polyethylene/polypropylene. An aluminum laminate (manufactured by Dai Nippon Printing Co., Ltd.) for secondary batteries was heat-sealed to form a bag-shaped container. The positive electrode, the separator, and the negative electrode, which were prepared as shown above, were stacked and inserted into the bag-shaped container. The electrolytic solution was a solution of 1.0 mol/L of LiPF₆ in a mixed solvent of ethylene carbonate and diethyl carbonate (50:50 in volume ratio). To the bag-shaped container was added 0.128 g (corresponding to 120% of the volume of the spaces between the particles) of the electrolytic solution, so that a lithium-ion secondary battery was prepared.

### Examples 2 to 7

Lithium-ion secondary batteries were prepared as in Example 1 except that the content of the solid oxide electrolyte LATP and the electrolytic solution disposed in spaces between particles of the positive electrode active material were changed to those shown in Table 1.

### Comparative Examples 1 and 2

Lithium-ion secondary batteries were prepared as in Example 1 except that the solid oxide electrolyte LATP was not added to the positive electrode and that the electrolytic solution disposed in spaces between particles of the positive electrode active material was changed to that shown in Table 1.

(Evaluation)

Each of the lithium-ion secondary batteries obtained in the examples and the comparative examples was evaluated as shown below.

(Initial Discharge Capacity)

The lithium-ion secondary battery was allowed to stand at the measurement temperature (25° C.) for 1 hour, then charged to 4.2 V with constant current at 0.33 C, then charged with a constant voltage of 4.2 V for 1 hour, then allowed to stand for 30 minutes, and then discharged to 2.5 V at a rate of 0.2 C, when its initial discharge capacity was measured. The results are shown in Table 1.

(Initial Cell Resistance)

After the measurement of the initial discharge capacity, the lithium-ion secondary battery was adjusted to a charge level (state of charge (5° C.)) of 50%. Next, the battery was pulse-discharged at a rate of 0.2 C for 10 seconds during which the voltage was measured. The voltage during the 10-second discharge was plotted against the current at 0.2 C in a graph with the current on the horizontal axis and the voltage on the vertical axis. Next, after being allowed to stand for 5 minutes, the battery was subjected to auxiliary charge until the SOC was returned to 50%, and then allowed to stand for 5 minutes.

The operation described above was performed at each of the rates: 0.5 C, 1 C, 2 C, 5 C, and 10 C. The voltage during the 10-second discharge was plotted against the current at each C rate. An approximate straight line was obtained from the plots, and the initial cell resistance of the lithium-ion secondary battery obtained in each of the examples was defined as the slope of the approximate straight line. The results are shown in Table 1.

(Discharge Capacity after Durability Test)

In a thermostatic chamber at 45° C., the battery was subjected to a charge-discharge cycle durability test including 500 cycles of constant-current charge at a rate of 1 C to 4.2 V and constant-current discharge at a rate of 2 C to 2.5 V. After the 500 cycles were completed, the thermostatic chamber was cooled to 25° C., in which after the discharge to 2.5 V, the battery was allowed to stand for 24 hours and then measured for discharge capacity after the durability test by the same method as that for the initial discharge capacity. The results are shown in Table 1.

(Cell Resistance after Durability Test)

After the measurement of the discharge capacity after the durability test, the lithium-ion secondary battery was charged until the SOC reached 50, as in the measurement of the initial cell resistance, and then measured for cell resistance after the durability test by the same method as that for the initial cell resistance. The results are shown in Table 1.

(Capacity Retention Rate)

The capacity retention rate was determined as the percentage ratio of the discharge capacity after the durability test to the initial discharge capacity. The results are shown in Table 1.

(Rate of Increase in Cell Resistance)

The rate of increase in cell resistance was determined as the percentage ratio of the cell resistance after the durability test to the initial cell resistance. The results are shown in Table 1.

(DSC Measurement)

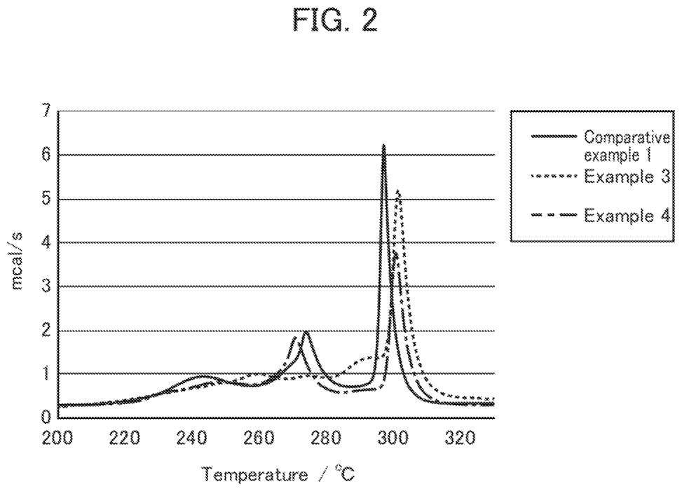

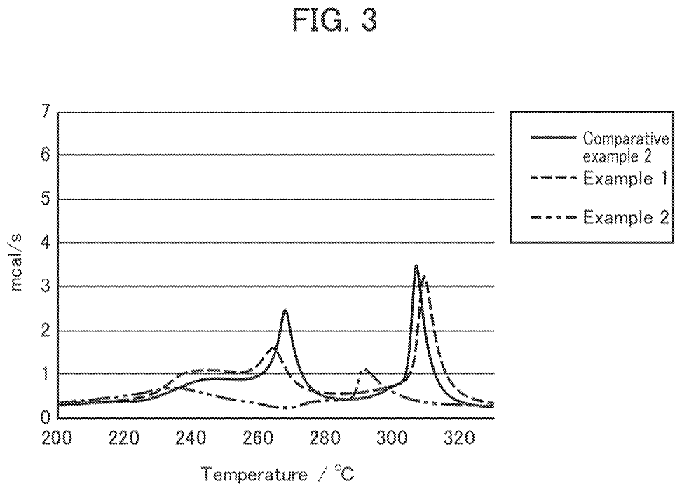

After the determination of the initial discharge capacity, the battery was charged to 4.2 V with constant current at 0.2 C. After the charge, the electrode was taken out of the battery, then washed with dimethyl carbonate (DMC), and then formed into a 4 φ piece. The resulting positive electrode piece and the electrolytic solution were sealed in an aluminum sample pan and then subjected to differential scanning calorimetry at a rate of temperature increase of 5° C./min using DSC3100SA manufactured by Bruker AXS. The results are shown in Table 1 and FIGS. 2 and 3.

TABLE 1

| | | | | | | | Volume | Mole |
|---|---|---|---|---|---|---|---|---|
| | | | High | | Low | | percentage | fraction |
| | | | boiling- | | boiling- | Volume | of | A of |
| | | | point, | | point, | precentage | high- | high |
| | | Type of | aprotic | | aprotic | of | dielectric | boiling- |
| | LATP | electrolytic | polar | | polar | electrolytic | oxide | point |
| | content | solution | solvent | | solvent | solution | solid | solvent |
| Example 1 | LATP 0.5 wt % | 1 mol/L LiPF6/ | EC | | DEC | 97.3 | 2.7 | 0.59 |
| | | EC:DEC = 5:5 | | | | | | |
| Example 2 | LATP 3 wt % | 1 mol/L LiPF6/ | EC | | MEC | 85.0 | 15.0 | 0.55 |
| | | EC:MSC = 5:5 | | | | | | |
| Example 3 | LATP [symbol] wt % | 1 mol/L LiPF6/ | EC | | DEC | 85.0 | 15.0 | 0.38 |
| | | EC:DEC = 3:7 | | | | | | |
| Example 4 | LATP 0.2 wt % | 1 mol/L LiPF6/ | EC | | DEC | 98.9 | 1.1 | 0.59 |
| | | EC:DEC = 5:5 | | | | | | |
| Example 5 | LATP 1 wt % | 1 mol/L LiPF6/ | EC | PC | MEC | 94.7 | 5.3 | 0.45 |
| | | EC:PC:MEC = [symbol] .5:0.5 | | | | | | |
| Example 6 | LATP 3 wt % | 1 mol/L LiPF6/ | EC | FEC | MEC | 85.0 | 15.0 | 0.47 |
| | | EC:FSC:MEC = 2:2:6 | | | | | | |
| Example 7 | LATP 5 wt % | 1 mol/L LiPF6/ | EC | | [symbol] | 76.4 | 23.6 | 0.20 |
| | | EC:DMC = 2:85 | | | | | | |
| Comparative | Absent | 1 mol/L LiPF6/ | EC | | DEC | | | |
| Example 1 | | EC:DEC = 3:7 | | | | | | |
| Comparative | Absent | 1 mol/L LiPF6/ | EC | | DEC | | | |
| Example 2 | | DC:DDC = 5:5 | | | | | | |

| | | | Deoxidation- | | | | Internal | | |
|---|---|---|---|---|---|---|---|---|---|
| | | | induced | | | | resistance | | |
| | Total | | disappearance | Discharge | Intial | Capacity | (Ω) at | | Rats (%) |
| | specific | | of DSC | capacity | internal | (mAh) | SOC 50% | Capacity | of |
| | surface | | peak of | (mAh) at | resistance | after 500 | after 500 | retention | increase |
| | area | | electrolytic | 0.2 C | (Ω) | cycles at | cycles at | rate | in |
| | B | A/B | solution | mAh | SOC50% | 45° C. | 45° C. | (%) | resistance |
| Example 1 | 0.040 | 14.8 | ◯ | 44.2 | 0.8 [symbol] | 39. [symbol] | 1.70 | 88.5 | 207.3 |
| Example 2 | 0.239 | 2.3 | ⊚ | 44.0 | 0.80 | 39. [symbol] | 1.60 | 88.9 | 200.0 |
| Example 3 | 0. [symbol] [symbol] 9 | 1.6 | ⊚ | 44.0 | 0.78 | 39.3 | 1.52 | 89.3 | 194.9 |
| Example 4 | 0.015 | 39.3 | Δ | 44.2 | 0.83 | 39. [symbol] | 1.82 | 88.5 | 219.3 |
| Example 5 | 0.080 | 5. [symbol] | ◯ | 44.1 | 0.80 | 39.4 | 1.65 | 89.3 | 206.3 |
| Example 6 | 0.239 | 2.0 | ⊚ | 44.2 | 0.80 | 39.3 | 1.67 | 88.9 | 208.8 |
| Example 7 | 0.397 | 0.5 | ◯ | 44.0 | 0.87 | 38.8 | 1.88 | 88.2 | 216.1 |
| Comparative | | | X | 44.4 | 0.87 | 39. [symbol] | 1.90 | 88.1 | 218.4 |
| Example 1 | | | | | | | | | |
| Comparative | | | X | 44.1 | 1.00 | 38.5 | 2.30 | 87.3 | 230.0 |
| Example 2 | | | | | | | | | |

[symbol]

indicates data missing or illegible when filed

### EXPLANATION OF REFERENCE NUMERALS

10: Lithium-ion secondary battery
1: Container
2: Positive electrode current collector
3: Positive electrode material mixture layer
4: Positive electrode
5: Negative electrode current collector
6: Negative electrode material mixture layer
7: Negative electrode
8: Separator
9: Electrolytic solution

1. A lithium-ion secondary battery electrode having an electrode material mixture layer comprising an electrode active material, a high-dielectric oxide solid, and an electrolytic solution, wherein
the electrolytic solution and the high-dielectric oxide solid are in a volume ratio of 99:1 to 76:24 in the electrode material mixture layer.

2. The lithium-ion secondary battery electrode according to claim 1, wherein the high-dielectric oxide solid and the electrolytic solution are disposed in spaces between particles of the electrode active material.

3. The lithium-ion secondary battery electrode according to claim 1 or 2, wherein
the electrolytic solution contains an aprotic polar solvent with a boiling point of 150° C. or more, and
the electrode material mixture layer has a ratio (A/B) of the mole fraction (A) of the aprotic polar solvent to the total specific surface area (B) (m²) of the high-dielectric oxide solid of 0.5 or more.

4. The lithium-ion secondary battery electrode according to any one of claims 1 to 3, wherein the electrode material mixture layer has a differential scanning calorimetry (DSC) curve with a reduction in exothermic peak at 270° C.

5. The lithium-ion secondary battery electrode according to any one of claims 1 to 4, wherein the high-dielectric oxide solid is a solid oxide electrolyte.

6. The lithium-ion secondary battery electrode according to claim 5, wherein the solid oxide electrolyte is at least one selected from the group consisting of Li₇La₃Zr₂O₁₂ (LLZO), Li_{0.75}La₃Zr_{1.75}Ta_{0.25}O₁₂ (LLZTO), Li_{0.33}La_{0.54}TiO₃ (LLTO), Li_{1.3}Al_{0.3}Ti_{1.7}(PO₄)₃ (LATP), and Li_{1.6}Al_{0.6}Ge_{1.4}(PO₄)₃ (LAGP).

7. The lithium-ion secondary battery electrode according to any one of claims 1 to 6, wherein the electrode active material has a volume filling factor of 60% or more based on the total volume of the electrode material mixture layer.

8. The lithium-ion secondary battery electrode according to any one of claims 1 to 7, wherein the electrode material mixture layer has a thickness of 40 μm or more.

9. The lithium-ion secondary battery electrode according to any one of claims 1 to 8, being a positive electrode.

10. The lithium-ion secondary battery electrode according to any one of claims 1 to 8, being a negative electrode.

11. A lithium-ion secondary battery, comprising: the lithium-ion secondary battery electrode according to any one of claims 1 to 10; and an electrolytic solution.
